(19) United States
(12) Patent Application Publication
(10) Pub. No.: US 2006/0014892 A1
(43) Pub. Date: Jan. 19, 2006

(54) Polyalkyldiallylamine-epihalohydrin resins as wet strength additives for papermaking and process for making the same

(76) Inventor: Armin Michel, Amersfoort (NL)

Correspondence Address: HERCULES INCORPORATED;HERCULES PLAZA, 1313 NORTH MARKET STREET, WILMINGTON, DE, 19894-0001, US

(21) Appl. No.: 10/890,592

(22) Filed: Jul. 14, 2004

(51) Int. Cl. D21H 17/52; C08G 73/02

(52) U.S. Cl. 524/800; 162/164.3

(57) ABSTRACT

The present invention relates to embodiments of a process for making polyalkyldiallylamine-epihalohydrin resins, the resultant resins and their uses as wet strength additives for papermaking. These resins are obtained by a process, wherein the salt of an alkyldiallylamine monomer is copolymerized and further reacted with epihalohydrin under carefully controlled reaction conditions.

### BACKGROUND OF THE INVENTION

1. Field of the Invention

The present invention relates to a process for making polyalkyldiallylamine-epihalohydrin resins, the resultant resins, and their uses as wet strength additives for papermaking.

2. Description of Background and Other Information

Polyamidoamine-epichlorohydrin resins (PAE resins), polyalkylenepolyamine-epichlorohydrin resins (PAPAE resins), amine polymer-epichlorohydrin resins, polyurylene-epichlorohydrin resins, polyamide-polyurylene-epichlorohydrin resins, and combinations of these resins with anionic polymers such as carboxymethyl cellulose (CMC), have been widely used in the manufacture of paper having high levels of wet strength.

Among the epihalohydrin-containing resins, the tertiary amine- based epoxide resins provide the highest resin efficiency (which generally refers to the amount of wet strength developed per unit mass added to the paper or that overall higher levels of wet strength result regardless of how much resin is added) as well as the highest off-machine wet strength (the ability to provide wet strength to a sheet of paper without aging). This is in contrast to most other wet strength resins which show an improvement in wet strength after aging for several days. The tertiary amine-based epoxide resins give high levels of wet strength as made. Of the various types of tertiary amine-based epoxide resins that have been described, the polymethyldiallylamine-epichlorohydrin resins are the most effective wet strength additives known for paper on a weight basis. A number of these resins have been previously described, as set forth below.

Polyalkyldiallylamine-epihalohydrin resins are known for their superior wet-strength performance when compared to PAE resins, however, the processes utilized to make such resins are inefficient and therefore costly. The embodiments of the present invention provide processes that allow for the manufacture of polyalkyldiallylamine-epihalohydrin resins in a more cost-effective manner.

Polyalkyldiallylamine-epichlorohydrin resins and variants thereof have been disclosed in a number of U.S. Patents, for example, U.S. Pat. No. 3,686,151 (Keim); U.S. Pat. No. 3,700,623 (Keim); U.S. Pat. No. 3,772,076 (Keim); U.S. Pat. No. 3,833,531, (Keim); U.S. Pat. No. 4,222,921 (Van Eenam); U.S. Pat. No. 4,233,417 (Van Eenam); U.S. Pat. No. 4,298,639 (Van Eenam); and U.S. Pat. No. 4,340,692 (Van Eenam).

Polymerization systems containing at least one quaternary amine monomer species are known in the art, however either the initiating step is carried out by redox systems comprising at least three components, two reducers and one oxidizer, as described in U.S. Pat. Nos. 3,700,623 and 3,833,531 (Keim); or the redox system consists of only two components, one oxidizing and one reducing agent as described in U.S. Pat. No. 3,678,098 (Rohm and Haas Company), but it is not used in conjunction with quarternary amines. These polymerization systems also initially add one of the reducing agents to a portion of the reaction mixture followed by simultaneous addition of the remaining components where the addition practice in this invention is simplified by the fact that it is a two component system, which eliminates the need for the pre-addition of one of the reducing agents.

Moreover, typically in the art after the first reducer has been added, the weight (mass) ratio of the remaining two components is 1:1 to utilize a sufficient radical polymerization process. However, the embodiments of the present invention allow for the weight ratio (or corresponding molar ratio) of the dual system to be changed significantly by greatly reducing the amount of oxidizer used in the two component system, still resulting in a very effective catalytic system.

### SUMMARY OF THE INVENTION

The present invention relates to embodiments of a process for making polyalkyldiallylamine-epihalohydrin resins, the resultant resins, and their uses as wet strength additives for papermaking wherein an embodiment of the process comprises:
(a) adding a salt of an alkyldiallylamine (ADM) monomer to water in a reaction vessel to form about a 30-65% aqueous salt solution;
(b) purging the aqueous salt solution with an inert gas;
(c) heating the aqueous salt solution to a temperature between about 50° C. to about 80° C., preferably until steps (e) and (f);
(d) adding a redox initiator system under an inert atmosphere to the aqueous salt solution over a period of about 2 to about 6 hours while stirring, preferably the redox initiator system is added continuously;
(e) simultaneously with step (d), adding at least one comonomer under an inert atmosphere to the aqueous salt solution over a period of about 2 to about 5 hours while stirring; thereby forming a copolymer, wherein the copolymer has an RSV ranging from about 0.10 dL/g to about 0.45 dL/g, preferably ranging from about 0.15 dL/g to about 0.25 dL/g, preferably the at least one comonomer is added continuously;
(f) maintaining contents of the vessel at about 50° C. to about 75° C. for a time period of about 30 to about 120 minutes;
(g) diluting the copolymer with an amount of water, thereby forming a copolymer solution having a solids content ranging from about 9% to about 20%, preferably ranging from about 9 to about 16%;
(h) adjusting the copolymer solution to a pH ranging from about 7 to about 10, preferably about 7.5 to about 10 and more preferably from about 8 to about 10;
(i) adding to this copolymer solution, an epihalohydrin in an amount to obtain a ratio of epihalohydrin:polymer amine functionality between about 0.85 and about 1.5 at a temperature between about 20° C. and about 50° C.; while either
(j1) simultaneously maintaining a pH between about 8 and about 10 and a temperature between about 20° C. and about 50° C. for a time period of about 2 to about 8 hours; or
(j2) simultaneously initially adjusting the pH to between about 8 and about 10 and allowing the pH to drift to as low as about 6.5 and maintaining a temperature between about 20° C. and about 50° C. for a time period of about 2 to about 8 hours; and
(k) increasing the temperature between about 60° C. to about 90° C. for about 0.5 to about 4 hours while adding sufficient acid to maintain a pH between about 1 to about 3.

Optionally, the embodiments of the present invention may further include steps (h1)-(h4), which comprise:
(h1) heating the copolymer solution to a temperature ranging from about 65° C. to about 75° C.;
(h2) adding the redox initiator as described above, under an inert atmosphere, to the copolymer solution over a period of time of about 20 to about 35 minutes while stirring, wherein the redox initiator and copolymer are in a weight-% ratio ranging from about 1:20 to about 1:80, more preferably the ratio is about 1:25, preferably the redox initiator is added continuously;
(h3) maintaining contents of the vessel at about 65° C. to about 75° C. for a time period of about 35 to about 75 minutes; and

(h4) cooling the copolymer solution to an ambient temperature.

The present invention further relates to the resins that are the reaction products of the above-described process.

Still further, the present invention relates the use of the resins as wet strength additives as well as to a cellulose matrix, preferably paper, comprising the resins.

### DETAILED DESCRIPTION OF THE INVENTION

Where a range of numerical values is recited herein, unless otherwise stated, the range is intended to include the endpoints thereof, and all integers and fractions within the range. It is not intended that the scope of the various embodiments of the invention be limited to the specific values recited when defining a range. Moreover, all ranges set forth herein are intended to include not only the particular ranges specifically described, but also any combination of values therein, including the minimum and maximum values recited.

The present invention relates to embodiments of a process for making polyalkyldiallylamine-epihalohydrin resins, and the resultant resins, wherein an embodiment of the process comprises:
(a) adding a salt of an alkyldiallylamine (ADAA) monomer to water in a reaction vessel to form about a 30-65% aqueous salt solution, preferably about a 35% to about a 55% aqueous salt solution, more preferably about a 40% to about a 45% aqueous salt solution, most preferably about a 42% aqueous salt solution;
(b) purging the aqueous salt solution with an inert gas;
(c) heating the aqueous salt solution to a temperature between about 50° C. to about 80° C., preferably until steps (e) and (f);
(d) adding a redox initiator system under an inert atmosphere to the aqueous salt solution over a period of about 2 to about 6 hours while stirring, preferably the redox initiator system is added continuously;
(e) simultaneously with step (d), adding at least one comonomer under an inert atmosphere to the aqueous salt solution over a period of about 2 to about 5 hours while stirring; thereby forming a copolymer, wherein the copolymer has an RSV ranging from about 0.10 dL/g to about 0.45 dL/g, preferably ranging from about 0.15 dL/g to about 0.25 dL/g, preferably the at least one comonomer is added continuously;
(f) maintaining contents of the vessel at about 50° C. to about 75° C. for a time period of about 30 to about 120 minutes;
(g) diluting the copolymer with an amount of water, thereby forming a copolymer solution having a solids content ranging from about 9% to about 20%;
(h) adjusting the copolymer solution to a pH ranging from about 7 to about 10, preferably about 7.5 to about 10 and more preferably from about 8 to about 10;
(i) adding to this copolymer solution, an epihalohydrin in an amount to obtain a ratio of epihalohydrin:polymer amine functionality between about 0.85 and about 1.5 at a temperature between about 20° C. and about 50° C.; while either
(j1) simultaneously maintaining a pH between about 8 and about 10 and a temperature between about 20° C. and about 50° C. for a time period of about 2 to about 8 hours; or
(j2) simultaneously initially adjusting the pH to between about 8 and about 10 and allowing the pH to drift to as low as about 6.5 and maintaining a temperature between about 20° C. and about 50° C. for a time period of about 2 to about 8 hours; and
(k) increasing the temperature between about 60° C. to about 90° C. for about 0.5 to about 4 hours while adding sufficient acid to maintain a pH between about 1 to about 3.

Moreover, the above-described process may optionally include steps (h1)-(h4) for a residual monomer burn-off, wherein the copolymer solution is heated and further amounts of the redox initiator are added to the copolymer solution (under an inert atmosphere, preferably nitrogen) in order to reduce both the remaining amounts of monomer and comonomer. Steps (h1)-(h4) serve to reduce or remove residual comonomers, particularly acrylamides, where the copolymer solution has been adjusted to a high pH value (typically between 8 and 11, preferably 10). This optional step is beneficial since the resulting resin will be less toxic due to the lower amounts of the comonomer, particularly acrylamides, which are carcinogenic. The optional steps (h1)-(h4), which are not required to obtain sufficient wet strength results, comprise:
(h1) heating the copolymer solution to a temperature ranging from about 65° C. to about 75° C.;
(h2) adding the redox initiator as described above, under an inert atmosphere, to the copolymer solution over a period of time of about 20 to about 35 minutes while stirring, wherein the redox initiator and copolymer are in a weight-% ratio ranging from about 1:20 to about 1:80, more preferably the ratio is about 1:25, preferably the redox initiator is added continuously;
(h3) maintaining contents of the vessel at about 65° C. to about 75° C. for a time period of about 35 to about 75 minutes; and
(h4) cooling the copolymer solution to an ambient temperature.

The synthesis of the ADM copolymer utilizes a copolymerization process, which is well known to those skilled in the art, is generally described in G. Odian, Principles of Polymerization, Second Edition, Chapter 3, John Wiley & Sons, New York (1981) and/or free radical cyclopolymerization as described in G. B. Butler, Cyclopolymerization and Cyclocopolymerization, Marcel Dekker, New York (1992).

The copolymerization of the ADM copolymer results in the formation of a cyclized copolymer backbone, referred to as a “cyclopolymerization”. The cyclic backbone structure can be a 5- or 6-membered ring, or a mixture thereof. These structures are shown below: 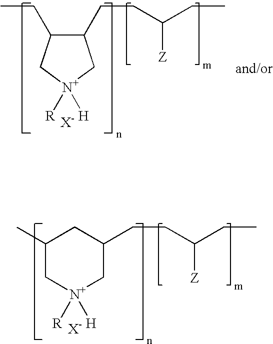
wherein Z is the comonomer and n and m represent the ratio of monomer to comonomer, for example the ADM salt and comonomer may be in a molar ratio ranging from about 15:85 to about 45:55.

Typically, the 5-membered ring structure is the predominant repeat unit found in this type of copolymer, however, no specific ring-type or ratio is required for the present invention. The relative amounts of the two structures will depend on a number of factors including the identity and size of the substituent —R, the reaction temperature, the reaction solids content, the specific initiator used and the identity of the complexing acid. The —R group may be an alkyl group, for example, methyl, ethyl, propyl, and butyl, wherein the alkyl group is small enough to maintain water solubility. The —R group may also be a hydroxyalkyl group or other type of substituted alkyl group.

In order to produce a resin, and ultimately paper or other cellulose matrices made using this resin, the embodiments of the current invention utilize salts (e.g. hydrohalide salts, phosphate salts, sulfate salts and nitrate salts) of a ADAA monomer prepared in an aqueous solution.

In step (a), a salt of an alkyldiallylamine monomer or a mixture of various salts is added to water in a reaction vessel to form about a 30-65% aqueous salt solution, preferably about a 35% to about a 55% aqueous salt solution, more preferably about a 40% to about a 45% aqueous salt solution, most preferably about a 42% aqueous salt solution. Those skilled in the art recognize and understand the appropriate method for forming the salt using a complexing acid.

The complexing acids suitable for forming the ADM monomer salt include the hydrohalide acids such as, for example, hydrochloric, hydrobromic, hydroiodic acids, sulfuric acid, nitric acid, phosphoric acid, methanesulfonic acid, and para-toluenesulfonic acid.

Suitable ADAA monomers for use in forming the salts include, but are not limited to, N-methyldiallylamine (MDAA, methyldiallylamine), N-ethyldiallylamine (EDAA, ethyldiallylamine), N-n-propyldiallylamine (PDAA, propyldiallylamine), N-isopropyldiallylamine, N-butyldiallylamine, N-tert-butyldiallylamine, N-sec-butyldiallylamine, N-pentyldiallyamine, N-n-hexyldiallylamine, N-acetamidodiallylamine, N-cyanomethyldiallylamine, N-β-propionamidodiallylamine, and N-(2-hydroxyethyl)diallylamine and mixtures thereof. The preferred monomer is MDM.

Typically the monomer has a high degree of purity, however, a wide range of purities may be used. For example with respect to MDM, the high degree of purity is preferably at least about 98.5%, more preferably at least about 99.3% and most preferably at least about 99.8%.

The monomers are copolymerized in the form of hydrohalide salts, preferably as the hydrochloride salt; phosphate salts, nitrate salts and sulfate salts.

Preferred hydrohalide salts include, but are not limited to, the hydrochloride salt of N-methyldiallylamine (MDAA.HCl), N-ethyldiallylamine (EDAA.HCl) and N-propyldiallylamine (PDM.HCl).

Preferred phosphate salts include, but are not limited to, the phosphate salt of methyldiallylammonium, ethyldiallylammonium, and propyldiallylammonium.

Preferred nitrate salts include, but are not limited to methyldiallylammonium, ethyldiallylammonium, and propyldiallylammonium.

Preferred sulfate salts include, but are not limited to, the sulfate salt of methyldiallylammonium, ethyldiallylammonium, and propyldiallylammonium.

In step (b), the aqueous salt solution should be purged with an inert gas such as, for example, nitrogen or argon in order to drive off oxygen. These inert gases are commercially available and used “as received” from the supplier. Purging is well known by those skilled in the art, wherein purging preferably occurs for at least about 45 minutes.

In step (c), the aqueous salt solution is then heated to a temperature ranging from about 50° C. to about 80° C., preferably from about 50° C. to about 70° C., more preferably from about 55° C. to about 70° C. and most preferably from about 60° C. to about 65° C.

In step (d), the copolymer polymerization is initiated by a redox (reduction-oxidation) catalytic system comprising two initiator solutions, the first containing a reducing agent and the second containing an oxidizing agent. The catalytic system of the embodiments of the present invention uses a dual catalyst system instead of a single thermally activated initiator, which provides for the efficient generation of free radicals and subsequent polymerization at lower temperatures.

Typically the reducing agent and oxidizing agent are used in a molar ratio ranging from about 1:0.1 to about 1:1, preferably about 1:0.1 to about 1:0.9.

Examples of suitable oxidizing agents include, but are not limited to, peroxide-type compounds, especially salts of the peroxidisulfuric acid such as sodium persulfate, potassium persulfate and ammonium persulfate or other peroxide catalysts such as tertiary-butyl hydroperoxide and hydrogen peroxide. The most preferred oxidizing agent is sodium peroxodisulfate (SPDS).

Examples of suitable reducing agents used in conjunction with above oxidizers include, but are not limited to, compounds of bivalent or tetravalent sulfur such as sulfides, sulfites, bisulfites, thiosulfates, hydrosulfites, metabisulfites salts and other reducing salts such as the sulfate of a metal which is capable of existing in more than one valence state such as cobalt, iron, manganese and copper. The most preferred reducing agent is sodium metabisulfite (SMBS).

The redox catalytic system comprises the combination of one reducing agent and one oxidizing agent. The preferred oxidizing agent is a peroxidisulfuric acid salt, and the corresponding reducing agent is one of sulfites, bisulfites and metabisulfites. A more preferred oxidizing agent is sodium persulfate or ammonium persulfate and a more preferred reducing agent is sodium bisulfite or sodium metabisulfite. Most preferably, the dual catalyst system comprises the combination of sodum persulfate (i.e. sodium peroxodisulfate (SPDS)) and sodium metabisulfite.

In general, the redox initiator system is continuously added as an aqueous salt solution over a period of time ranging from about 2 to about 6 hours while stirring (preferably about 150-200 RPM's). In total, the feed duration of the redox initiator system is preferably about 5 to about 30 minutes longer than the comonomer feed, and more preferably the additional feed time is about 10 to 20 minutes longer than the comonomer feed duration. The aqueous salt solution is to be held under an inert atmosphere as provided for above.

The preferred continuous feed practice described herein is based on a concurrent addition of the comonomer and the dual catalyst system. In general, concurrent addition means that there is a constant flow of all ingredients, without interruption, at the same time to the reaction vessel. Furthermore, at the point when the comonomer feed has finished, the practice to extend the initiator solutions feed beyond the comonomer feed duration may be either just to continue the feed of the dual catalyst system without interruption for the given time period above or the feed may be interrupted with the end of the comonomer feed and resumed to a later point in time for the time period given above. The feed rate is calculated by the expression ‘parts to feed’ divided by the ‘feed duration’, which is in the case of the comonomer in Example 1 (part 1): 187.0 g/180 min=1.039 g/min and for each initiator solution is 32.1 g/190 min=0.169 g/min. Since the feed duration is a fixed factor in this equation only the ‘parts to feed’ need to be changed in order to vary the scale of the process. Thus, a 1000 times bigger scale will result in a feed rate of 1.039 kg/min for the comonomer and 0.169 kg/min for the catalyst solution respectively.

The dual catalyst initiator/monomer, wherein the monomer includes both the ADAA monomer and the comonomer, are generally in a molar ratio ranging from about 1:35 to about 1:185; preferably from about 1:60 to about 1:120 and most preferably the ratio is 1:90.

In step (e), which is simultaneous with the continuous addition of the redox initiator system, at least one comonomer is added to the heated aqueous salt solution under an inert atmosphere as provided for above. The comonomer addition occurs over a time period ranging from about 2 hours to about 5 hours, preferably from about 2.5 hours to about 4 hours, and more preferably about 3.5 hours. As set forth in step (f), during the continuous addition of the redox initiator and comonomer the aqueous salt solution should be maintained at a temperature ranging from about 50° C. to about 75° C., preferably from about 55° C. to about 70° C., more preferably from about 60° C. to about 65° C.; and maintained at the temperature given above for a time period ranging from about 30 minutes to about 120 minutes, preferably from about 40 minutes to about 120 minutes, more preferably from about 60 minutes to about 120 minutes after the comonomer feed has stopped.

The ADM monomer is copolymerized with comonomers that are soluble in water. Generally at least one comonomer is used, such that the use of mixtures of two or more comonomers is also contemplated. Preferably, the ADAA monomer can be copolymerized with at least one comonomer including, but not limited to, vinyl monomers such as acrylamide, methacrylamide, acrylic acid, methacrylic acid, itaconic acid, alkyl(meth)acrylates such as methyl acrylate, methyl methacrylate (MMA), ethyl acrylate, ethyl methacrylate, propyl acrylate, propyl methacrylate, BMH, butyl acrylate (BA), butyl methacrylate, hydroxyalkyl(meth)acrylates, hydroxyethyl acrylate (HEA), hydroxyethyl methacrylate, hydroxypropyl acrylate, hydroxypropyl methacrylate, hydroxybutyl methacrylate (HBMA), styrene, ethylene, glyceryl acrylate and glyceryl methacrylate, hydroxypropyl methacrylamide (HPMA) and mixtures thereof; more preferably, acrylamide, methacrylamide, acrylic acid, methacrylic acid, itaconic acid, and mixtures thereof, most preferably acrylamide and acrylic acid and mixtures thereof.

Typically, the ADAA salt and the at least one comonomer are in a molar ratio ranging from about 15:85 to about 45:55, preferably ranging from 18:82 to about 40:60, and most preferably 34:66.

Another alternative method of preparing the ADM copolymer with the appropriate reduced specific viscosity range is to start with a high molecular weight ADAA copolymer and reduce the molecular weight by means of shear energy or the use of ultrasound, each of which is well known to those skilled in the art.

The copolymer solution resulting from steps (a)-(f) should have a particular reduced specific viscosity (RSV). The desired RSV of the ADM copolymer is not particularly limited, but preferably ranges from about 0.10 to about 0.45 dL/g, preferably between about 0.15 to about 0.30 dL/g, more preferably between about 0.20 to about 0.25 dL/g, and most preferably between about 0.21 to about 0.23 dL/g.

Generally, the reduced specific viscosity is determined by a two-step method. First the flow time of a polymer solution (PFT) in a capillary viscometer is measured, wherein the polymer solution has a set concentration. Second, the flow time of the solvent (SFT) is measured. Thus, the polymer flow time minus the solvent flow time is divided by the solvent flow time ((PFT-SFT)/SFT=SV), thereby resulting in the specific viscosity. Subsequently, the specific viscosity is divided by the polymer concentration to yield the reduced specific viscosity. For example, the RSV is measured by capillary viscometry of a 2.0 weight percent solution of the polymer in 1.0N NH₄Cl solution at 25° C.

In step (g), the copolymer is diluted with an amount of water, thereby forming a copolymer solution having a solids content ranging from about 9% to about 20%, preferably ranging from about 9% to about 16%. Those skilled in the art recognize that factors such as pH and temperature are interrelated and able to be adjusted to result in the appropriate solids content. Generally, prior to dilution, the copolymer solution has a solids content ranging from about 30% to about 50%, preferably ranging from about 35% to about 45%.

In step (h) the pH is adjusted using a base solution, preferably an aqueous sodium hydroxide (NaOH) solution ranging from about 5% to about 15%, and more preferably from about 8 to about 11%.

Steps (i) and either (j1) or (j2) comprise the reaction of the ADAA copolymer with an epihalohydrin, preferably epichlorohydrin. Preferably, the epihalohydrin is added over a time period of about 30 seconds, however, it may be added as quickly as possible.

The amount of epihalohydrin to be mixed with the copolymer solution should result in a ratio of epihalohydrin to pADAA amine functionality from about 0.85 to about 1.5 and preferably from about 0.95 to about 1.45; and more preferably from about 1.0 to about 1.45; and most preferably from about 1.10 to about 1.20. In step (i), the copolymer/epihalohydrin solution should be maintained at a temperature ranging from about 20° C. to about 50° C.

Simultaneously with the temperature maintenance, the copolymer/epihalohydrin solution should be kept at a pH of about 8 to about 10 either by continuous addition of base during the reaction or a one-time pH adjustment at the beginning of the reaction and allowing the pH to drift, for a period of time ranging from about 2 hours to about 8 hours. Preferably an aqueous sodium hydroxide (NaOH) solution as described above is used for the pH adjustments.

Those skilled in the art will recognize and understand the use of pH, time and temperature ranges and their relationship with one another as given above in order to prepare a resin with the desired characteristics, for example the resin preparation time, epihalohydrin residual levels, and/or resin viscosity (molecular weight). The parameters should be chosen in these given ranges according to the RSV of the starting copolymer and the epihalohydrin to amine ratio since these factors have a significant impact on the reaction time of the resin preparation. For example, a resin process proceeding at a very fast rate may not be easy controlled in terms of the buildup of the resin's viscosity. This can result in gelation of the resin, rendering it unusable. On the other hand, a resin process taking a considerably long time to buildup viscosity is not suitable for commercial production of these resins (reaction times of greater than 24 hours).

Subsequent to the pH adjustment, in step (k) the temperature is increased to a range of about 60° C. to about 90° C., preferably from about 70° C. to about 80° C., more preferably to about 70° C. to about 75° C.; for a time period ranging from about 0.5 hours to about 4 hours, preferably from about 1 hour to about 3 hours, more preferably to about 2 hours to about 3 hours; while adding sufficient amounts of acid to maintain the pH in the range of about 1 to about 3, preferably about 2.5.

Suitable acids may include sulfuric acid, nitric acid, phosphoric acid, formic acid, acetic acid and hydrochloric acid. A preferred acid used is hydrochloric acid.

Generally, the residual ADM monomer content is equal to or less than about 0.15% (1500 ppm). The content of the residual comonomer is equal to or less than about 0.05% (500 ppm).

The application of the optional burn-off process steps (e.g. steps (h1)-(h4)) allows for the reduction of the residual ADAA monomer content to an amount that is less than or equal to about 0.005% (50 ppm) as well as reduction of the residual comonomer content to an amount that is less than or equal to about 0.001% (10 ppm).

The residual monomer content is typically measured by high-pressure liquid chromatography system (HPLC), for example, a Waters 600 Controller, Waters column oven, Waters 486 Tunable Absorbance Detector (manufactured by Waters, The Netherlands) and an Autosampler Dynamax model Al-200 Rainin (manufactured by Varian, The Netherlands) with the column material Zorbax Stablebond (SB-C18) 250 mm×4.6 mm, 5 μm particle size, 80 A pore size, USCL013425 (manufactured by Agilent Technologies, The Netherlands).

The residual ADM monomer content is preferably measured by Head Space analysis, using a Perkin Elmer Autosystem XL gas chromatograph (manufactured by Perkin Elmer, The Netherlands) equipped with J&W column material, 60 m db-1, 0.25 mm diameter, 0.25 μm film thickness (manufactured by Agilent Technologies, The Netherlands)

The present invention avoids the use of organic solvents and organic chain transfer agents, which aids in the reduction of handling toxic material during the production cycle and of volatile organic compounds (VOC) present in the product. A reduction in the VOC's is reduces air emissions and pollution.

The resulting polyADAA-epihalohydrin resins have significantly lower levels of residual epihalohydrin hydrolysis products in paper products or other cellulose matrices made using these resins as a wet strength additive. Generally, the present invention contemplates an amount of epihalohydrin and epihalohydrin hydrolysis by-product residuals of less than or equal to 3.0%, based on the total concentration of epihalohydrin, 1,3-dihalopropanol (1,3-DHP), 2,3-dihalopropanol (2,3-DHP) and 3-halopropanediol (HPD).

The embodiments of the resins described herein are used as wet strength additives for processes used in making cellulose matrices, preferably paper. Generally, a cellulose matrix will comprises, but is not limited to, preferably about 0.1 to about 3% of a resin on a weight (active solids) basis, more preferably from about 0.2% to about 1.5%.

### EXAMPLES

The present invention is further defined in the following Examples, in which all parts and percentages are by weight, unless otherwise indicated. It should be understood that these Examples, while indicating preferred embodiments of the invention, are given by way of illustration only. From the above discussion and these Examples, one skilled in the art can ascertain the essential characteristics of this invention, and without departing from the spirit and scope thereof, can make various changes and modifications of the invention to adapt it to various usage and conditions.

### Example 1

### Part 1: Synthesis of the Copolymer of Methyldiallylammonium Chloride and Acryl Amide (18/82)

A 64% aqueous solution of methyldiallylammonium chloride (66.6 g) and deionized water (32.1 g) were charged into a reaction vessel provided with a stirrer. The mixture was purged with high purity nitrogen gas for 45 minutes. Two aqueous initiator solutions (Redox initiator system) were prepared by dissolving 0.2 g of sodium peroxodisulfate (SPDS) in 31.9 mL of deionized water, and 1.8 g of sodium metabisulfite (SMBS) in 30.3 mL of deionized water followed by purging both initiator solutions with high purity N₂ for 20 minutes. The stirrer was started and an insulated heating mantle Electromantel (EMC1000/CE) was placed under the reaction flask and the reaction mixture was heated to 60° C. controlled by a Digital Controller MC810 (both manufactured by Electrothermal Engineering Ltd). While maintaining the N₂ purge and keeping the reaction at 60° C., the SPDS/SMBS initiator solutions and a 50% aqueous solution of acryl amide (187 g) were continuously added to the reaction flask over a period of 180 minutes for the acryl amide feed and over a period of 190 minutes for the redox initiator (SMBS/SPDS) feed. When all the initiator solutions have been added the reaction mixture was maintained at 60° C. for an additional 50 minutes.

The copolymer content of the product was 41% at a pH of 4.6 and the RSV of the copolymer was 0.337 dL/g.

### Example 1

### Part 2: Synthesis of the pMDAA/AAM.HCl-epichlorohydrin Resin

A sample of the MDAA/AAM copolymer of Part 1 (65.0 g; RSV of the copolymer was 0.337 dL/g) and deionized water (50.0 g) were charged into a reaction vessel provided with a stirrer. While stirring at 200 rpm, the pH of the solution was adjusted from 4.15 to 8.51 using a 5% aqueous NaOH solution (4.86 g). At this point additional deionized water (50.0 g) was charged into the reaction vessel and the temperature of the reaction mixture was at 25° C. A portion of 5.96 g epichlorohydrin was added to the mixture over a period of 30 seconds. During the next 30 minutes the temperature had increased to 26° C. and the pH had reached 8.76. Then, an insulated heating mantle Electromantel (EMC0500/CE) was placed under the reaction flask and the reaction mixture was heated to 50° C. controlled by a Digital Controller MC810 (both manufactured by Electrothermal Engineering Ltd). The Gardner-Holt viscosity and pH were monitored closely throughout the resin synthesis. The pH had dropped to 7.26 after the temperature reached 50° C. After 292 minutes, the Gardner-Holt viscosity reached a value of “F” and the pH had dropped to 6.91. At this point the pH was adjusted to about 2.0 by adding a 17% aqueous HCl solution (0.5 g). The resin solution was then heated to 80° C. and additional 17% aqueous HCl solution was delivered to the reaction mixture to maintain the pH at 2.0-2.5. The temperature was maintained at 80° C. for one hour and the pH was finally adjusted to 2.5. The total amount of 17% aqueous HCl solution used to adjust the pH in this step was 3.65 g. The total solid (oven method) of the final product was 18.1%.

### Example 1

### Part 3: Synthesis of the pMDAA/AAM.HCl-epichlorohydrin Resin

A sample of the MDAA/AAM copolymer of Part 1 (65.0 g; RSV of the copolymer was 0.337 dL/g) and deionized water (50.0 g) were charged into a reaction vessel provided with a stirrer. While stirring at 200 rpm, the pH of the solution was adjusted from 4.27 to 8.51 using a 5% aqueous NaOH solution (4.5 g). At this point additional deionized water (50.0 g) was charged into the reaction vessel and the temperature of the reaction mixture was at 25° C. A portion of 7.45 g epichlorohydrin was added to the mixture over a period of 30 seconds. During the next 30 minutes the temperature had increased to 27° C. and the pH had reached 8.76. Then, an insulated heating mantle Electromantel (EMC0500/CE) was placed under the reaction flask and the reaction mixture was heated to 50° C. controlled by a Digital Controller MC810 (both manufactured by Electrothermal Engineering Ltd). The Gardner-Holt viscosity and pH were monitored closely throughout the resin synthesis. After 287 minutes, the Gardner-Holt viscosity reached a value of “F” and the pH had dropped to 7.08. At this point the pH was adjusted to about 2.0 by adding a 17% aqueous HCl solution (0.5 g). The resin solution was then heated to 80° C. and additional 17% aqueous HCl solution was delivered to the reaction mixture to maintain the pH at 2.0-2.5. The temperature was maintained at 80° C. for one hour and the pH was finally adjusted to 2.0. The total amount of 17% aqueous HCl solution used to adjust the pH in this step was 4.58 g.

The total solid (oven method) of the final product was 18.4%.

### Example 2

### Part 1: Synthesis of the Copolymer of Methyldiallylammonium Chloride and Acryl Amide (30/70)

After charging a reaction vessel with 25.3 g methyldiallylamine and 50.0 g deionized water, the reaction vessel was cooled with an ice bath. The ice bath was used to maintain the temperature below 20° C. Using an addition funnel, 22.8 g of 36% hydrochloric acid (HCl) was slowly added to the stirred reaction vessel. The rate of addition was adjusted in order to maintain the temperature of the reaction mixture between 12 and 15° C. Upon finishing the addition of the HCl solution the ice bath was removed and the reaction mixture was stirred at ambient temperature for one hour. At this point the reaction mixture was a clear light yellow solution. The mixture was then purged with high purity nitrogen gas for 45 minutes. Two aqueous initiator solutions (Redox initiator system) were prepared by dissolving 0.1 g of sodium peroxodisulfate (SPDS) in 16.9 mL of deionized water, and 0.7 g of sodium metabisulfite (SMBS) in 16.3 mL of deionized water followed by purging both initiator solutions with high purity N₂ for 20 minutes. The stirrer was started and an insulated heating mantle Electromantel (EMC1000/CE) was placed under the reaction flask and the reaction mixture was heated to 60° C. controlled by a Digital Controller MC810 (both manufactured by Electrothermal Engineering Ltd). While maintaining the N₂ purge and keeping the reaction at 60° C., the SPDS/SMBS initiator solutions and a 50% aqueous solution of acryl amide (74.6 g) were continuously added to the reaction flask over a period of 178 minutes for the acryl amide feed and over a period of 186 minutes for the redox initiator (SMBS/SPDS) feed. When all the initiator solutions have been added the reaction mixture was maintained at 60° C. for one additional hour.

The copolymer content of the product was 36.4% at a pH of 4.7 and the RSV of the copolymer was 0.408 dL/g.

### Example 2

### Part 2: Synthesis of the pMDAA/AAM.HCl-epichlorohydrin Resin

A sample of the MDAA/MM copolymer of Part 1 (65.0 g; RSV of the copolymer was 0.408 dL/g) and deionized water (80.0 g) were charged into a reaction vessel provided with a stirrer. While stirring at 200 rpm, the pH of the solution was adjusted from 4.4 to 8.5 using a 5% aqueous NaOH solution (5.9 g). At this point additional deionized water (28.0 g) was charged into the reaction vessel and the temperature of the reaction mixture was at 24° C. A portion of 7.86 g epichlorohydrin was added to the mixture over a period of 30 seconds. During the next 30 minutes the temperature had increased to 28° C. and the pH had reached 8.71. Then, an insulated heating mantle Electromantel (EMC0500/CE) was placed under the reaction flask and the reaction mixture was heated to 50° C. controlled by a Digital Controller MC810 (both manufactured by Electrothermal Engineering Ltd). The Gardner-Holt viscosity and pH were monitored closely throughout the resin synthesis. The pH had dropped to 7.1 after the temperature reached 49° C. After 165 minutes, the Gardner-Holt viscosity reached a value of “D” and the pH had dropped to 6.97. At this point the pH was adjusted to about 2.0 by adding a 17% aqueous HCl solution (0.5 g). The resin solution was then heated to 80° C. and additional 17% aqueous HCl solution was delivered to the reaction mixture to maintain the pH at 2.0-2.5. The temperature was maintained at 80° C. for one hour and the pH was finally adjusted to 2.34. The total amount of 17% aqueous HCl solution used to adjust the pH in this step was 4.45 g.

The total solid (oven method) of the final product was 15.7%.

### Example 3

### Part 1: Synthesis of the Copolymer of Methyldiallylammonium Chloride and Acryl Amide (34/66)

A 65% aqueous solution of methyldiallylammonium chloride (189.6 g) and deionized water (81.8 g) were charged into a reaction vessel provided with a stirrer. The mixture was purged with high purity nitrogen gas for 45 minutes. Two aqueous initiator solutions (Redox initiator system) were prepared by dissolving 0.3 g of sodium peroxodisulfate (SPDS) in 48.8 mL of deionized water, and 2.3 g of sodium metabisulfite (SMBS) in 46.7 mL of deionized water followed by purging both initiator solutions with high purity N₂ for 20 minutes. The stirrer was started and an insulated heating mantle Electromantel (EMC1000/CE) was placed under the reaction flask and the reaction mixture was heated to 60° C. controlled by a Digital Controller MC810 (both manufactured by Electrothermal Engineering Ltd). While maintaining the N₂ purge and keeping the reaction at 60° C., the SPDS/SMBS initiator solutions and a 50% aqueous solution of acryl amide (230.3 g) were continuously added to the reaction flask over a period of 180 minutes for the acryl amide feed and over a period of 190 minutes for the redox initiator (SMBS/SPDS) feed. When all the initiator solutions have been added the reaction mixture was maintained at 60° C. for an additional 50 minutes.

The copolymer content of the product was 41.5% at a pH of 4.8 and the RSV of the copolymer was 0.338 dL/g.

### Example 3

### Part 2: Synthesis of the pMDAA/AAM.HCl-epichlorohydrin Resin

A sample of the MDAA/MM copolymer of Part 1 (538.4 g; RSV of the copolymer was 0.338 dL/g) and deionized water (800.0 g) were charged into a reaction vessel provided with a stirrer. While stirring at 200 rpm, the pH of the solution was adjusted from 5.55 to 8.5 using a 5% aqueous NaOH solution (55.6 g). At this point additional deionized water (374.7 g) was charged into the reaction vessel and the temperature of the reaction mixture was at 25° C. A portion of 103.96 g epichlorohydrin was added to the mixture over a period of 30 seconds. During the next 37 minutes the temperature had increased to 30° C. and the pH had reached 8.76. Then, an insulated heating mantle Electromantel (EMC0500/CE) was placed under the reaction flask and the reaction mixture was heated to 50° C. controlled by a Digital Controller MC810 (both manufactured by Electrothermal Engineering Ltd). The Gardner-Holt viscosity and pH were monitored closely throughout the resin synthesis. The pH had dropped to 7.63 after the temperature reached 45° C. After 369 minutes, the Gardner-Holt viscosity reached a value of “D” and the pH had dropped to 7.04. At this point the pH was adjusted to about 1.0 by adding a 17% aqueous HCl solution (41.6 g).

This resin contained ND ppm epichlorohydrin, 2.3% 1,3-DCP, 108 ppm 2,3-DCP and 4500 ppm CPD. The total solid (oven method) of the final product was 15.8%.

### Example 4

### Part 1: Synthesis of the Copolymer of Methyldiallylammonium Chloride and Acryl Amide (34/66)

A 65% aqueous solution of methyldiallylammonium chloride (191.8 g) and deionized water (89.4 g) were charged into a reaction vessel provided with a stirrer. The mixture was purged with high purity nitrogen gas for 45 minutes. Two aqueous initiator solutions (Redox initiator system) were prepared by dissolving 0.6 g of sodium peroxodisulfate (SPDS) in 49.1 mL of deionized water, and 4.7 g of sodium metabisulfite (SMBS) in 44.9 mL of deionized water followed by purging both initiator solutions with high purity N₂ for 20 minutes. The stirrer was started and an insulated heating mantle Electromantel (EMC1000/CE) was placed under the reaction flask and the reaction mixture was heated to 70° C. controlled by a Digital Controller MC810 (both manufactured by Electrothermal Engineering Ltd). While maintaining the N₂ purge and keeping the reaction at 70° C., the SPDS/SMBS initiator solutions and a 50% aqueous solution of acryl amide (233 g) were continuously added to the reaction flask over a period of 200 minutes for the acryl amide feed and over a period of 210 minutes for the redox initiator (SMBS/SPDS) feed. When all the initiator solutions have been added the reaction mixture was maintained at 70° C. for an additional 50 minutes.

The copolymer content of the product was 41.8% at a pH of 5.5 and the RSV of the copolymer was 0.229 dL/g. The Acryl amide residual level at pH of 5.5 was 35 ppm and for Methyl diallylamine 1400 ppm respectively.

### Example 4

### Part 2: Synthesis of the pMDAA/AAM.HCl-epichlorohydrin Resin

A sample of the MDAA/MM copolymer of Part 1 (110.0 g; RSV of the copolymer was 0.229 dL/g) and deionized water (240.0 g) were charged into a reaction vessel provided with a stirrer. While stirring at 200 rpm, the pH of the solution was adjusted from 5.06 to 8.58 using a 10% aqueous NaOH solution (5.48 g). At this point the temperature of the reaction mixture was at 21° C. A portion of 16.81 g epichlorohydrin was added to the mixture over a period of 30 seconds. The reaction Was then heated to 40° C. and the Gardner-Holt viscosity and pH were monitored. The pH was maintained in the range of 8.0 to 8.5 by incremental additions of 8% aqueous NaOH solution. A total 32.5 g of 8% aqueous NaOH solution was added over a period of 110 minutes. After 134 minutes, the Gardner-Holt viscosity reached a value of “D”. At this point the pH was adjusted to about 2.0 by adding a 17% aqueous HCl solution (10.94 g). The resin solution was then heated to 75° C. and additional 17% aqueous HCl solution was delivered to the reaction mixture to maintain the pH at 1.0-2.0. The temperature was maintained at 75° C. for two hours and the pH was finally adjusted to 1.95. The total amount of 17% aqueous HCl solution used to adjust the pH in this step was 24.09 g.

This resin contained 19 ppm epichlorohydrin, 0.88% 1,3-DCP, 149 ppm 2,3-DCP and 2240 ppm CPD. The total solid (oven method) of the final product was 15.0%. The acryl amide residual level at pH of 1.95 was 219 ppm and for methyl diallylamine 222 ppm respectively.

### Example 5

### Part 1: Synthesis of the Copolymer of Methyldiallylammonium Phosphate and Acryl Amide (39/61)

A 58.3% aqueous solution of methyldiallylammonium phosphate (262.4 g) and deionized water (100 g) were charged into a reaction vessel provided with a stirrer. The mixture was purged with high purity nitrogen gas for 45 minutes. Two aqueous initiator solutions (Redox initiator system) were prepared by dissolving 0.7 g of sodium peroxodisulfate (SPDS) in 36.8 mL of deionized water, and 5.3 g of sodium metabisulfite (SMBS) in 32.1 mL of deionized water followed by purging both initiator solutions with high purity N₂ for 20 minutes. The stirrer was started and an insulated heating mantle Electromantel (EMC1000/CE) was placed under the reaction flask and the reaction mixture was heated to 70° C. controlled by a Digital Controller MC810 (both manufactured by Electrothermal Engineering Ltd). While maintaining the N₂ purge and keeping the reaction at 70° C., the SPDS/SMBS initiator solutions and a 50% aqueous solution of acryl amide (162.6 g) were continuously added to the reaction flask over a period of 200 minutes for the acryl amide feed and over a period of 210 minutes for the redox initiator (SMBS/SPDS) feed. When all the initiator solutions have been added the reaction mixture was maintained at 70° C. for one additional hour.

The copolymer content of the product was 40.7% at a pH of 4.4 and the RSV of the copolymer was 0.131 dL/g.

### Example 5

### Part 2: Synthesis of the pMDAA/AAM.H₃PO₄-epichlorohydrin Resin

A sample of the MDAA/MM copolymer of Part 1 (110.0 g; RSV of the copolymer was 0.131 dL/g) and deionized water (200.0 g) were charged into a reaction vessel provided with a stirrer. While stirring at 200 rpm, the pH of the solution was adjusted from 4.3 to 8.5 using a 10% aqueous NaOH solution (59.1 g). At this point the temperature of the reaction mixture was at 25° C. A portion of 11.17 g epichlorohydrin was added to the mixture over a period of 30 seconds. The reaction was then heated to 40° C. and the Gardner-Holt viscosity and pH were monitored. The pH was maintained in the range of 8.45 to 8.55 by incremental additions of 8% aqueous NaOH solution using the pH stat function of a titrator (Mettler Toledo, DL53 Titrator). A total 37.4 g of 8% aqueous NaOH solution was added over a period of 248 minutes. After 270 minutes, the Gardner-Holt viscosity reached a value of “D”. At this point the reaction was killed by adding a 17% aqueous HCl solution (13.39 g). The resin solution was then heated to 75° C. and additional 17% aqueous HCl solution was delivered to the reaction mixture to maintain the pH at 1.5-2.0. The temperature was maintained at 75° C. for two hours and the pH was finally adjusted to 2.0. The total amount of 17% aqueous HCl solution used to adjust the pH in this step was 43.06 g.

This resin contained ND ppm epichlorohydrin, 1200 ppm 1,3-DCP, 15 ppm 2,3-DCP and 808 ppm CPD. The total solid (oven method) of the final product was 14.7%.

### Example 6

### Part 1: Synthesis of the Copolymer of Methyldiallylammonium Sulfate and Acryl Amide (39/61)

A 52% aqueous solution of methyldiallylammonium sulfate (278.6 g) and deionized water (65 g) were charged into a reaction vessel provided with a stirrer. The mixture was purged with high purity nitrogen gas for 45 minutes. Two aqueous initiator solutions (Redox initiator system) were prepared by dissolving 0.7 g of sodium peroxodisulfate (SPDS) in 45.8 mL of deionized water, and 5.5 g of sodium metabisulfite (SMBS) in 41 mL of deionized water followed by purging both initiator solutions with high purity N₂ for 20 minutes. The stirrer was started and an insulated heating mantle Electromantel (EMC1000/CE) was placed under the reaction flask and the reaction mixture was heated to 70° C. controlled by a Digital Controller MC810 (both manufactured by Electrothermal Engineering Ltd). While maintaining the N₂ purge and keeping the reaction at 70° C., the SPDS/SMBS initiator solutions and a 50% aqueous solution of acryl amide (201.4 g) were continuously added to the reaction flask over a period of 200 minutes for the acryl amide feed and over a period of 210 minutes for the redox initiator (SMBS/SPDS) feed. When all the initiator solutions have been added the reaction mixture was maintained at 70° C. for one additional hour.

The copolymer content of the product was 40.3% at a pH of 4.5 and the RSV of the copolymer was 0.191 dL/g.

### Example 6

### Part 2: Synthesis of the pMDAA/AAM.H₂SO₄-epichlorohydrin Resin

A sample of the MDAA/AAM copolymer of Part 1 (95.0 g; RSV of the copolymer was 0.191 dL/g) and deionized water (192.0 g) were charged into a reaction vessel provided with a stirrer. While stirring at 200 rpm, the pH of the solution was adjusted from 4.32 to 8.55 using a 8% aqueous NaOH solution (3.98 g). At this point the temperature of the reaction mixture was at 21° C. A portion of 14.98 g epichlorohydrin was added to the mixture over a period of 30 seconds. The reaction was then heated to 40° C. and the Gardner-Holt viscosity and pH were monitored. The pH was maintained in the range of 8.45 to 8.55 by incremental additions of 8% aqueous NaOH solution using a DL53 Titrator (manufactured by Mettler Toledo). A total 44.25 g of 8% aqueous NaOH solution was added over a period of 143 minutes. After 192 minutes, the Gardner-Holt viscosity reached a value of “D”. At this point the pH was adjusted from 8.06 to about 2.0 by adding a 17% aqueous HCl solution (10.83 g). The resin solution was then heated to 75° C. and additional 17% aqueous HCl solution was delivered to the reaction mixture to maintain the pH at 1.5-2.0. The temperature was maintained at 75° C. for one hour and 40 minutes and the pH was finally adjusted to 2.0. The total amount of 17% aqueous HCl solution used to adjust the pH in this step was 23.87 g.

This resin contained ND ppm epichlorohydrin, 0.66% 1,3-DCP, 132 ppm 2,3-DCP and 3217 ppm CPD. The total solid (oven method) of the final product was 15.5%.

### Example 7

### Part 1: Synthesis of the Copolymer of Ethyidiallylammonium Chloride and Acryl Amide (34/66)

A 50% aqueous solution of ethyldiallylammonium chloride (259.4 g) and deionized water (44.7 g) were charged into a reaction vessel provided with a stirrer. The mixture was purged with high purity nitrogen gas for 45 minutes. Two aqueous initiator solutions (Redox initiator system) were prepared by dissolving 0.84 g of sodium peroxodisulfate (SPDS) in 46.4 mL of deionized water, and 6.73 g of sodium metabisulfite (SMBS) in 40.5 mL of deionized water followed by purging both initiator solutions with high purity N₂ for 20 minutes. The stirrer was started and an insulated heating mantle Electromantel (EMC1000/CE) was placed under the reaction flask and the reaction mixture was heated to 60° C. controlled by a Digital Controller MC810 (both manufactured by Electrothermal Engineering Ltd). While maintaining the N₂ purge and keeping the reaction at 60° C., the SPDS/SMBS initiator solutions and a 50% aqueous solution of acryl amide (213.8 g, adjusted to a pH of 3.1) were continuously added to the reaction flask over a period of 240 minutes for the acryl amide feed. The feed of the initiator solutions was first interrupted with the end of the acryl amide feed and resumed after 60 minutes for additional 12 minutes (total feed time of 252 min at the end) while maintaining the temperature at 60° C. When all the initiator solutions have been added, the reaction mixture was maintained at 60° C. for additional 48 minutes and then cooled to room temperature.

The copolymer content of the product was 41.4% at a pH of 2.9 and the RSV of the copolymer was 0.176 dL/g.

### Example 7

### Part 2. Synthesis of the pEDAA/AAM.HCl-epichlorohydrin Resin

A sample of the EDAA/AAM copolymer of Part 1 (110.0 g; RSV of the copolymer was 0.176 dL/g) and deionized water (240.0 g) were charged into a reaction vessel provided with a stirrer. While stirring at 200 rpm, the pH of the solution was adjusted to about 9.0 using a 11% aqueous NaOH solution (9.59 g). At this point the temperature of the reaction mixture was at 22° C. A portion of 16.37 g epichlorohydrin was added to the mixture over a period of 30 seconds. The reaction was then heated to 40° C. and the Gardner-Holt viscosity and pH were monitored. The pH was maintained at about 8.5 for about 220 minutes and at about 9.5 for about 45 minutes by incremental additions of 11% aqueous NaOH solution (39.9 g). After 265 minutes, the Gardner-Holt viscosity reached a value of “D” and the pH was adjusted to about 2.0 by adding an 18% aqueous HCl solution (2.9 g). The resin solution was then heated to 75° C. and additional 18% aqueous HCl solution was delivered to the reaction mixture to maintain the pH between 2.0-3.0. The temperature was maintained at 75° C. for 75 minutes and the pH was finally adjusted to 2. The total amount of 18% aqueous HCl solution used to adjust the pH in this step was 29.8 g.

This resin contained ND ppm epichlorohydrin, 0.87% 1,3-DCP, 155 ppm 2,3-DCP and 2688 ppm CPD. The total solid (oven method) of the final product was 15.1%.

### Example 8

### Part 1: Synthesis of the Copolymer of Ethyldiallylammonium Nitrate and Acryl Amide (34/66)

A 50% aqueous solution of ethyldiallylammonium nitrate (291.5 g) and deionized water (53.5 g) were charged into a reaction vessel provided with a stirrer. The mixture was purged with high purity nitrogen gas for 45 minutes. Two aqueous initiator solutions (Redox initiator system) were prepared by dissolving 0.81 g of sodium peroxodisulfate (SPDS) in 44.7 mL of deionized water, and 6.5 g of sodium metabisulfite (SMBS) in 39.1 mL of deionized water followed by purging both initiator solutions with high purity N₂ for 20 minutes. The stirrer was started and an insulated heating mantle Electromantel (EMC1000/CE) was placed under the reaction flask and the reaction mixture was heated to 60° C. controlled by a Digital Controller MC810 (both manufactured by Electrothermal Engineering Ltd). While maintaining the N₂ purge and keeping the reaction at 60° C., the SPDS/SMBS initiator solutions and a 50% aqueous solution of acryl amide (213.8 g, adjusted to a pH of 3.1) were continuously added to the reaction flask over a period of 240 minutes for the acryl amide feed. The feed of the initiator solutions was first interrupted with the end of the acryl amide feed and resumed after 60 minutes for additional 10 minutes (total feed time of 250 min at the end) while maintaining the temperature at 60° C. When all the initiator solutions have been added, the reaction mixture was maintained at 60° C. for additional 50 minutes and then cooled to room temperature.

The copolymer content of the product was 41.3% at a pH of 4.0 and the RSV of the copolymer was 0.139 dL/g.

### Example 8

### Part 2. Synthesis of the pEDAA/AAM.HNO₃-epichlorohydrin Resin

A sample of the EDAA/AAM copolymer of Part 1 (110.0 g; RSV of the copolymer was 0.139 dL/g) and deionized water (230.0 g) were charged into a reaction vessel provided with a stirrer. While stirring at 200 rpm, the pH of the solution was adjusted to about 9.0 using a 11% aqueous NaOH solution (7.42 g). At this point the temperature of the reaction mixture was at 22° C. A portion of 15.02 g epichlorohydrin was added to the mixture over a period of 30 seconds. The reaction was then heated to 40° C. and the Gardner-Holt viscosity and pH were monitored. The pH was maintained at about 9.0 by incremental additions of 11% aqueous NaOH solution (37.6 g). After 330 minutes, the Gardner-Holt viscosity reached a value of “D” and the pH was adjusted to about 2.0 by adding a 18% aqueous HCl solution (3.4 g). The resin solution was then heated to 75° C. and additional 18% aqueous HCl solution was delivered to the reaction mixture to maintain the pH between 2.0-2.5. The temperature was maintained at 75° C. for 47 minutes and the pH was finally adjusted to 2.10. The total amount of 18% aqueous HCl solution used to adjust the pH in this step was 17.3 g.

This resin contained 11 ppm epichlorohydrin, 0.64% 1,3-DCP, 117 ppm 2,3-DCP and 3782 ppm CPD. The total solid (oven method) of the final product was 15.5%.

### Example 9

### Part 1: Synthesis of the Copolymer of Propyidiallylammonium Nitrate and Acryl Amide (34/66)

A 50% aqueous solution of propylldiallylammonium nitrate (300.7 g) and deionized water (56.5 g) were charged into a reaction vessel provided with a stirrer. The mixture was purged with high purity nitrogen gas for 45 minutes. Two aqueous initiator solutions (Redox initiator system) were prepared by dissolving 0.78 g of sodium peroxodisulfate (SPDS) in 42.9 mL of deionized water, and 6.24 g of sodium metabisulfite (SMBS) in 37.5 mL of deionized water followed by purging both initiator solutions with high purity N₂ for 20 minutes. The stirrer was started and an insulated heating mantle Electromantel (EMC1000/CE) was placed under the reaction flask and the reaction mixture was heated to 60° C. controlled by a Digital Controller MC810 (both manufactured by Electrothermal Engineering Ltd). While maintaining the N₂ purge and keeping the reaction at 60° C., the SPDS/SMBS initiator solutions and a 50% aqueous solution of acryl amide (205.3 g, adjusted to a pH of 3.0) were continuously added to the reaction flask over a period of 240 minutes for the acryl amide feed. The feed of the initiator solutions was first interrupted with the end of the acryl amide feed and resumed after 60 minutes for additional 10 minutes (total feed time of 250 min at the end) while maintaining the temperature at 60° C. When all the initiator solutions have been added, the reaction mixture was maintained at 60° C. for additional 50 minutes and then cooled to room temperature.

The copolymer content of the product was 41.2% at a pH of 4.3 and the RSV of the copolymer was 0.123 dL/g.

### Example 9

### Part 2. Synthesis of the pPDAA/AAM.HNO₃-epichlorohydrin Resin

A sample of the PDAA/AM copolymer of Part 1 (110.0 g; RSV of the copolymer was 0.123 dL/g) and deionized water (230.0 g) were charged into a reaction vessel provided with a stirrer. While stirring at 200 rpm, the pH of the solution was adjusted to about 8.6 using a 11% aqueous NaOH solution (3.54 g). At this point the temperature of the reaction mixture was at 22° C. A portion of 14.39 g epichlorohydrin was added to the mixture over a period of 30 seconds. The reaction was then heated to 40° C. and the Gardner-Holt viscosity and pH were monitored. The pH was maintained at about 9.0 by incremental additions of 11% aqueous NaOH solution (42.65 g). After 362 minutes, the Gardner-Holt viscosity reached a value of “D” and the pH was adjusted to about 2.0 by adding a 18% aqueous HCl solution (3.3 g). The resin solution was then heated to 75° C. and additional 18% aqueous HCl solution was delivered to the reaction mixture to maintain the pH between 2.0-2.5. The temperature was maintained at 75° C. for 140 minutes and the pH was finally adjusted to 2.2. The total amount of 18% aqueous HCl solution used to adjust the pH in this step was 20.2 g.

This resin contained <10 ppm epichlorohydrin, 0.55% 1,3-DCP, 95 ppm 2,3-DCP and 3050 ppm CPD. The total solid (oven method) of the final product was 15.4%.

### Example 10

### Part 1: Synthesis of the Copolymer of Methyldiallylammonium Chloride and Acryl Amide (34/66)

A 50% aqueous solution of methyldiallylammonium chloride (260.2 g) and deionized water (42.9 g) were charged into a reaction vessel provided with a stirrer. The mixture was purged with high purity nitrogen gas for 45 minutes. Two aqueous initiator solutions (Redox initiator system) were prepared by dissolving 0.9 g of sodium peroxodisulfate (SPDS) in 50.9 mL of deionized water, and 7.4 g of sodium metabisulfite (SMBS) in 44.5 mL of deionized water followed by purging both initiator solutions with high purity N₂ for 20 minutes. The stirrer was started and an insulated heating mantle Electromantel (EMC1000/CE) was placed under the reaction flask and the reaction mixture was heated to 60° C. controlled by a Digital Controller MC810 (both manufactured by Electrothermal Engineering Ltd). While maintaining the N₂ purge and keeping the reaction at 60° C., the SPDS/SMBS initiator solutions and a 50% aqueous solution (adjusted to pH of 3.12 with a 36% aqueous HCl solution) of acryl amide (243.2 g) were continuously added to the reaction flask over a period of 244 minutes for the acryl amide feed and over a period of 250 minutes for the redox initiator (SMBS/SPDS) feed. The initiator feed was temporarily stopped at the end of the acryl amide feed and resumed after 60 minutes for additional 7 minutes. When all the initiator solutions have been added the reaction mixture was maintained at 60° C. for additional 53 minutes.

The copolymer content of the product was 41.9% at a pH of 3.6 and the RSV of the copolymer was 0.243 dL/g. The acryl amide residual level at pH of 3.6 was 108 ppm and for methyl diallylamine <122 ppm respectively.

A 14% solution of the same copolymer adjusted to pH 11 prior to the residual analysis showed an acryl amide residual level of 126 ppm.

### Example 10

### Part 2. Synthesis of the pMDAA/AAM.HCl-epichlorohydrin Resin

A sample of the MDAA/MM copolymer of Part 1 (110.0 g; RSV of the copolymer was 0.243 dL/g) and deionized water (240.0 g) were charged into a reaction vessel (under constant N₂ atmosphere) provided with a stirrer. While stirring at 200 rpm, the pH of the solution was adjusted from 3.5 to 10.0 using a 11% aqueous NaOH solution (30.26 g). At this point the temperature of the reaction mixture was at 22° C. The polymer solution was then heated to 75° C. At this point, a 1% aqueous sodium peroxodisulfate (SPDS) solution (15.1 g) and a 10% sodium metabisulfite (SMBS) solution (16.65 g) were added over a period of 30 minutes to the polymer mixture. After ending the SMBS/SPDS initiator feed, the temperature of the reaction solution was maintained at 75° C. for additional 38 minutes and then cooled to RT. A portion of 17.39 g epichlorohydrin was added to the mixture over a period of 30 seconds. The reaction mixture was maintained at a temperature of about 23° C. and the Gardner-Holt viscosity and pH were monitored. After 109 minutes, the Gardner-Holt viscosity reached a value of “E-”. At this point the pH was adjusted from 8.8 to about 2.0 by adding a 18% aqueous HCl solution 3.37 g). The resin solution was then heated to 75° C. and additional 18% aqueous HCl solution was delivered to the reaction mixture to maintain the pH at 2.0-3.0. The temperature was maintained at 75° C. for 1 hours and 20 minutes and the pH was finally adjusted to about 2.4. The total amount of 18% aqueous HCl solution used in the resin stabilization process was 19.7 g.

This resin contained 14 ppm epichlorohydrin, 0.76% 1,3-DCP, 75 ppm 2,3-DCP and 1353 ppm CPD. The total solid (oven method) of the final product was 15%. The acryl amide level at pH 2.4 was 1 ppm. The acryl amide residual level at pH of 10 was 8 ppm and for methyl diallylamine <42 ppm respectively.

### Example 11

### Paper Strength Evaluations

Paper has been made on a pilot paper machine (Type: Officine Meccaniche Toschi; S.p.A. (Lucca) Marlia (Italy)) at pH 7.5 using a 50:50 blend of bleached softwood/hardwood Kraft pulp, refined to a Schopper-Riegel number (or its Canadian Standard Freeness) of 36°. The paper was prepared having a 65 g/m² basis weight containing 1.0% of treated resin (based on the active solids of untreated resin). The paper was made at a speed of 4.0 m/min. and dried, running through a series of 7 drying cylinders (temp. of drying cylinders: 55, 75, 95, 105, 20 and 20° C.), to a moisture content of 3.81%. All the paper samples were oven-cured at 80° C. for 30 minutes prior to testing. Dry and wet tensile strength properties were determined using the Hercules method for Paper Strength Testing P8.2a-004 (Tensile Testing), which is a combination of following methods: ISO 1924 part 2 (1994)—Determination of tensile properties; Constant rate of elongation method, Tappi T 494 om-1 (revised 2001) Tensile properties of paper and paperboard (using constant rate of elongation apparatus), SCAN P38:80 (1980)—Tensile strength, stretch and tensile energy absorption. The results are shown below in Table 1.

For comparative purposes some paper was prepared with no strength additives included (blank), while other paper was prepared using a commercial wet strength additive. The commercial wet strength additive used was Kymene® 557H, a polyamidoamine-epichlorohydrin (PAE) wet strength that is an azetidinium-funtional PAE (supplied by Hercules Incorporated, Europe). All PADAA-epichlorohydrin resins were activated by caustic addition to result in a 3% active solids resin solution. In general, the activation procedure was performed as follows: A portion of the resin was combined with deionized water and a 10% aqueous solution of NaOH and was mixed for at least 30 minutes prior to use. Results of the paper testing are shown in Table 1.

TABLE 1
Strength Properties of Paper Made With Strength Additives

| Strength | Basis Wt. | Dry Tensile | Wet Tensile |
|---|---|---|---|
| Additive | [g/m²] | [kN/m] | [kN/m] |
| None (blank) | 64.5 | 3.82 | 0.04 |
| 1% Kymene ® 557H | 62.4 | 3.55 | 0.78 |
| 1% Example 1 part 2 | 62.6 | 4.27 | 0.85 |
| 1% Example 1 part 3 | 65.5 | 4.39 | 0.92 |
| 1% Example 2 part 2 | 63.1 | 4.59 | 1.05 |

### Example 12

### Paper Strength Evaluations

An additional set of paper was prepared to measure the effects of the resins on wet and dry tensile properties of paper. The paper preparation procedure was very similar to that described in Example 11 (pH 7.5, 50:50 blend of bleached softwood/hardwood Kraft pulp, Schopper-Riegel number of 35°, 65 g/m² basis weight containing 1.0% of treated resin, speed of 5.0 m/min., moisture content of 3.2%). Results of the paper testing are shown in Table 2.

TABLE 2
Strength Properties of Paper Made With Strength Additives

| Strength | Basis Wt. | Dry Tensile | Wet Tensile |
|---|---|---|---|
| Additive | [g/m²] | [kN/m] | [kN/m] |
| None (blank) | 66.7 | 4.01 | 0.04 |
| 1% Kymene ® 557H | 66.2 | 5.44 | 1.09 |
| 1% Example 4 part 2 | 65.9 | 5.62 | 1.40 |
| 1% Example 5 part 2 | 66.9 | 5.14 | 1.17 |
| 1% Example 6 part 2 | 66.6 | 5.80 | 1.45 |

### Example 13

### Paper Strength Evaluations

An additional set of paper was prepared to measure the effects of the resins on wet and dry tensile properties of paper. The paper preparation procedure was very similar to that described in Example 11 (pH 7.35, 50:50 blend of bleached softwood/hardwood Kraft pulp, Schopper-Riegel number of 34°, 65 g/m² basis weight containing 1.0% of treated resin, speed of 5.0 m/min., moisture content of 2.9%). Results of the paper testing are shown in Table 3.

TABLE 3
Strength Properties of Paper Made With Strength Additives

| Strength | Basis Wt. | Dry Tensile | Wet Tensile |
|---|---|---|---|
| Additive | [g/m²] | [kN/m] | [kN/m] |
| None (blank) | 64.7 | 5.53 | 0.06 |
| 1% Kymene ® 557H | 63.9 | 6.36 | 1.33 |
| 1% Example 7 part 2 | 65.2 | 6.56 | 1.42 |
| 1% Example 8 part 2 | 63.2 | 6.51 | 1.35 |

### Example 14

### Paper Strength Evaluations

An additional set of paper was prepared to measure the effects of the resins on wet and dry tensile properties of paper. The paper preparation procedure was very similar to that described in Example 11 (pH 7.2, 50:50 blend of bleached softwood/hardwood Kraft pulp, Schopper-Riegel Freeness of 32°, 65 g/m² basis weight containing 1.0% of treated resin, speed of 5.0 m/min., moisture content of 4.3%). Results of the paper testing are shown in Table 4.

TABLE 4
Strength Properties of Paper Made With Strength Additives

| Strength | Basis Wt. | Dry Tensile | Wet Tensile |
|---|---|---|---|
| Additive | [g/m²] | [kN/m] | [kN/m] |
| None (blank) | 65.8 | 4.72 | 0.1 |
| 1% Kymene ® 557H | 65.2 | 5.54 | 1.09 |
| 1% Example 10 part 2 | 65.7 | 6.05 | 1.36 |

What is claimed is:

1. A process for making polyalkyldiallylamine-epihalohydrin resins comprising:
(a) adding a salt of an alkyldiallylamine monomer to water in a reaction vessel to form about a 30% to about a 65% aqueous salt solution;
(b) purging the aqueous salt solution with an inert gas;
(c) heating the aqueous salt solution to a temperature between about 50° C. to about 80° C.;
(d) adding a redox initiator system under an inert atmosphere to the aqueous salt solution over a period of about 2 to about 6 hours while stirring;
(e) simultaneously with step (d), adding at least one comonomer under an inert atmosphere to the aqueous salt solution over a period of about 2 to about 5 hours while stirring;
(f) maintaining contents of the vessel at about 50° C. to about 75° C. for a time period of about 30 to about 120 minutes, thereby forming a copolymer;
(g) diluting the copolymer with an amount of water, thereby forming a copolymer solution having a solids content ranging from about 9% to about 20%;
(h) adjusting the copolymer solution to a pH ranging from about 7 to about 10;
(i) adding to this copolymer solution, an epihalohydrin in an amount to obtain a ratio of epihalohydrin:polymer amine functionality between about 0.85 and about 1.5 at a temperature between about 20° C. and about 50° C.; while either
(j1) simultaneously maintaining a pH between about 8 and about 10 and a temperature between about 20° C. and about 50° C. for a time period of about 2 to about 8 hours; or
(j2) simultaneously initially adjusting the pH to between about 8 and about 10 and allowing the pH to drift to as low as about 6.5 and maintaining a temperature between about 20° C. and about 50° C. for a time period of about 2 to about 8 hours; and
(k) increasing the temperature between about 60° C. to about 90° C. for about 0.5 to about 4 hours while adding sufficient acid to maintain a pH between about 1 to about 3.

2. The process according to claim 1 further comprising:
(h1) heating the copolymer solution to a temperature ranging from about 65° C. to about 75° C.;
(h2) adding the redox initiator as described above, under an inert atmosphere, to the copolymer solution over a period of time of about 20 to about 35 minutes while stirring, wherein the redox initiator and copolymer are in a weight-% ratio ranging from about 1:20 to about 1:80;
(h3) maintaining contents of the vessel at about 65° C. to about 75° C. for a time period of about 35 to about 75 minutes; and
(h4) cooling the copolymer solution to an ambient temperature.

3. The process according to claim 1, wherein the alkyldiallylamine monomer is selected from N-methyldiallylamine, N-ethyldiallylamine, N-n-propyldiallylamine, N-isopropyldiallylamine, N-butyldiallylamine, N-tert-butyldiallylamine, N-sec-butyldiallylamine, N-pentyldiallyamine, N-n-hexyldiallylamine, N-acetamidodiallylamine, N-cyanomethyldiallylamine, N-βpropionamidodiallylamine, and N-(2-hydroxyethyl)diallylamine and mixtures thereof.

4. The process according to claim 3, wherein the alkyldiallylamine monomer is N-methyldiallylamine, N-ethyldiallylamine or mixtures thereof.

5. The process according to claim 1 where the salt of the alkyldiallylamine monomer is a hydrohalide salt, phosphate salt, nitrate salt or sulfate salt.

6. The process according to claim 5, wherein the hydrohalide salt of the alkyldiallylamine monomer is a hydrochloride salt.

7. The process according to claim 5 where the hydrohalide salt is the hydrochloric salt of N-methyldiallylamine, the hydrochloric salt of N-ethyldiallylamine or the hydrochloric salt of N-propyldiallylamine.

8. The process according to claim 5, where the phosphate salt is the phosphate salt of N-methyldiallylamine, the phosphate salt of N-ethyldiallylamine or the phosphate salt of N-propyldiallylamine.

9. The process according to claim 5, wherein the nitrate salt is the nitrate salt of N-methyldiallylamine, the nitrate salt of N-ethyldiallylamine or the nitrate salt of N-propyldiallylamine.

10. The process according to claim 5, wherein the sulfate salt is the sulfate salt of N-methyldiallylamine, the sulfate salt of N-ethyldiallylamine or the sulfate salt of N-propyldiallylamine.

11. The process according to claim 1, wherein the aqueous salt solution is about a 35% to about a 65% aqueous salt solution.

12. The process according to claim 11, wherein the aqueous salt solution is about a 40% to about a 45% aqueous salt solution.

13. The process according to claim 12, wherein the aqueous salt solution is about a 42% aqueous salt solution.

14. The process according to claim 1, wherein the inert gas of step (b) is nitrogen or argon.

15. The process according to claim 1, where in step (c) the aqueous salt solution is heated to a temperature between about 50° C. to about 70° C.

16. The process according to claim 15, where in step (c) the aqueous salt solution is heated to a temperature between about 55° C. to about 70° C.

17. The process according to claim 16, where in step (c) the aqueous salt solution is heated to a temperature between about 60° C. to about 65° C.

18. The process according to claim 1, wherein the redox initiator comprises a first initiator solution containing a reducing agent and a second initiator solution containing an oxidizing agent.

19. The process according to claim 18, where the oxidizing agent is selected from peroxide-type compounds, tertiary-butyl hydroperoxide, hydrogen peroxide or mixtures thereof.

20. The process according to claim 19, wherein the peroxide-type compound is a salt of the peroxidisulfuric acid,

21. The process according to claim 20, wherein the salt of the peroxidisulfuric acid is sodium persulfate, potassium persulfate or ammonium persulfate.

22. The process according to claim 21, wherein the salt of the peroxidisulfuric acid is sodium peroxodisulfate.

23. The process according to claim 14, where the reducing agent is selected from compounds of bivalent or tetravalent sulfur or a metal capable of existing in more than one valence state.

24. The process according to claim 23, wherein the compounds of bivalent or tetravalent sulfur are selected from sulfides, sulfites, bisulfites, thiosulfates, hydrosulfites, metabisulfites salts or mixtures thereof.

25. The process according to claim 23, wherein the metal capable of existing in more than one valence state is cobalt, iron, manganese, copper or mixtures thereof.

26. The process according to claim 24, wherein the reducing agent is sodium metabisulfite.

27. The process according to claim 1, wherein the oxidizing agent is peroxidisulfuric acid salt, and the reducing agent is one of sulfites, bisulfites or metabisulfites.

28. The process according to claim 27, wherein the oxidizing agent is sodium persulfate or ammonium persulfate and the reducing agent is sodium bisulfite or sodium metabisulfite.

29. The process according to claim 28, wherein the oxidizing agent is sodum persulfate and the reducing agent is sodium metabisulfite.

30. The process according to claim 18, wherein the reducing agent and oxidizing agent are in a molar ratio ranging from about to about 1:0.1 to about 1:0.9.

31. The process according to claim 1, wherein the redox initiator and monomer are in a ratio ranging from about 1:35 to about 1:185.

32. The process according to claim 31, wherein the redox initiator and monomer are in a ratio ranging from about 1:60 to about 1:120.

33. The process according to claim 32, wherein the redox initiator and monomer are in a ratio of about 1:90.

34. The process according to claim 1, where in step (d) the inert atmosphere comprises nitrogen or argon gas.

35. The process according to claim 1, where in step (d) the redox initiator is continuously added.

36. The process according to claim 1, wherein the at least one comonomer is selected from vinyl monomers, alkyl(meth)acrylates hydroxypropyl methacrylamide (HPMA) and mixtures thereof; more preferably, acrylamide, methacrylamide, acrylic acid, methacrylic acid, itaconic acid, and mixtures thereof.

37. The process according to claim 36, wherein the at least one comonomer is selected from acrylamide, acrylic acid and mixtures thereof.

38. The process according to claim 36, wherein the alkyl(meth)acrylates is selected from methyl acrylate, methyl methacrylate, ethyl acrylate, ethyl methacrylate, propyl acrylate, propyl methacrylate, BMH, butyl acrylate, butyl methacrylate, hydroxyalkyl(meth)acrylates, hydroxyethyl acrylate, hydroxyethyl methacrylate, hydroxypropyl acrylate, hydroxypropyl methacrylate, hydroxybutyl methacrylate, styrene, ethylene, glyceryl acrylate glyceryl methacrylate, and mixtures thereof.

39. The process according to claim 1, wherein the at least one comonomer is added continuously.

40. The process according to claim 1, wherein the ADM salt and the at least one comonomer are in a molar ratio ranging from about 15:85 to about 45:55.

41. The process according to claim 40, wherein the ADAA salt and the at least one comonomer are in a molar ratio ranging from about 18:82 to about 40:60.

42. The process according to claim 41, wherein the ADAA salt and the at least one comonomer are in a molar ratio of about 34:66.

43. The process according to claim 1, where in step (e) inert atmosphere comprises nitrogen or argon gas.

44. The process according to claim 1, where in step (e) the reduced specific viscosity of the copolymer is between about 0.10 dL/g and about 0.45 dL/g.

45. The process according to claim 44, where in step (e) the reduced specific viscosity of the alkyldiallylamine copolymer is between 0.15 dL/g and about 0.30 dL/g.

46. The process according to claim 45, where in step (e) the reduced specific viscosity of the alkyldiallylamine copolymer is between 0.20 dL/g and about 0.25 dL/g.

47. The process according to claim 46, wherein the reduced specific viscosity of the alkyldiallylamine copolymer is between 0.21 dL/g and about 0.23 dL/g.

48. The process according to claim 1, where in step (g) the copolymer solution has a solids content of about 9 to about 16%.

49. The process according to claim 1, where in step (h) the pH of the copolymer solution ranges from about 7.5 to about 10.

50. The process according to claim 49, where in step (h) the pH of the copolymer solution ranges from about 8 to about 10.

51. The process according to claim 1, wherein the epihalohydrin is epichlorohydrin.

52. The process according to claim 1, wherein the ratio of epihalohydrin and polymer amine ranges from about 0.95 to about 1.45.

53. The process according to claim 52, wherein the ratio of epihalohydrin and polymer amine ranges from about 1.0 to about 1.45.

54. The process according to claim 53, wherein the ratio of epihalohydrin and polymer amine ranges from about 1.10 to about 1.20.

55. The process according to claim 1, where in step (k) the acid is sulfuric acid, nitric acid, phosphoric acid, formic acid, acetic acid and hydrochloric acid.

56. The process according to claim 55, where in step (k) the mineral acid is hydrochloric acid.

57. The process according to claim 2, where in step (h2) the weight-% ratio of redox initiator and copolymer is from about 1:20 to about 1:80.

58. The process according to claim 57, where in step (h2) the weight-% ratio of redox initiator and copolymer is about 1:25.

59. The process according to claim 2, wherein the redox initiator is added continuously.

60. A resin comprising the reaction product of the process according to claim 1.

61. A wet strength additive comprising the resin according to claim 60.

62. A cellulose matrix comprising the resin of claim 61.
